(19) United States
(12) Patent Application Publication
(10) Pub. No.: US 2004/0074757 A1
(43) Pub. Date: Apr. 22, 2004

(54) Method and apparatus for phase change enhancement

(76) Inventor: Kingston Owens, Bedford, NH (US)

Correspondence Address: BROMBERG & SUNSTEIN LLP, 125 SUMMER STREET, BOSTON, MA, 02110-1618, US

(21) Appl. No.: 10/636,303

(22) Filed: Aug. 7, 2003

Related U.S. Application Data
(60) Provisional application No. 60/401,813, filed on Aug. 7, 2002.
(60) Provisional application No. 60/425,820, filed on Nov. 13, 2002.

(51) Int. Cl. B01D 3/02; B01D 3/04; C10B 29/00

(52) U.S. Cl. 202/155; 159/DIG. 15; 159/DIG. 8; 202/158; 202/172; 202/237; 202/267.1

(57) ABSTRACT

A method and device for enhancing distillation in an evaporator. The evaporator includes phase change chambers, such as vertically-oriented cylindrical evaporation tubes. Each chamber has an evaporation region that can be heated externally. Each chamber has an inlet for introducing liquid to the chamber and an outlet opening for allowing vapor to exit from the chamber. Packing is inserted into one or more chambers to enhance distillation. The packing may include a rod with bristles emanating from the rod. Other chamber packing may include multiple rods or a mesh.

The present application claims priority from United States provisional patent application ser No. 60/401,813, atty docket no. 1062/C49, filed Aug. 7, 2002, entitled “Method and Apparatus for Boiling Enhancement in a Rising Film Evaporator.” The present application also claims priority from U.S. provisional patent application Ser No. 60/425,820, atty docket no. 1062/C48, filed Nov. 13, 2002, entitled “Pressurized Vapor Cycle Liquid Distillation.” Each of these applications is incorporated herein by reference in its entirety.

### TECHNICAL FIELD

The present invention pertains to improvements for the conversion of liquid to vapor, such as the phase change that takes place in an evaporator.

### BACKGROUND ART

The conversion of liquid to vapor is a fundamental step in many processes. For a variety of reasons, such as time and energy limitations, it may be advantageous to make this phase change more efficient. For example, one method of achieving more efficient phase change is though the use of thin film evaporation. Thin film evaporation, however, is typically achieved using apparatus that includes very small opening or spraying devices. This apparatus can easily clog, particularly when the source liquid contains contaminants. The apparatus may also be sensitive to movement and positioning of the apparatus. What is needed is an invention that allows for an increase in the net rate of phase change efficiency similar to the efficiencies obtainable from thin film evaporation, without the limitations and sensitivities typically experienced with thin film evaporation.

For example, vapor compression distillation has proved useful for purifying liquids, e.g., turning salt water into potable water. Such devices frequently employ an evaporator chamber comprising a set of vertically oriented tubes, which tubes are heated on their exteriors. The heated tubes create vapor from a liquid that is input to the tubes through openings in the bottom of the tubes. The vapor that emerges from each tube is compressed and heat from the vapor is then transferred to the liquid in the tubes by passing the compressed vapor over the outside of the tubes. The vapor condenses as it transfers its heat and the resultant distillate is drawn off. A vapor compression distillation device is disclosed in The Naval Sea Systems Command (Sea-03Z43), Naval Ships' Technical Manual, Chapter 531, Desalination Volume 2, Vapor Compression Distilling Plants, #S9086-SC-STM020/CH-531V2R2, Sep. 1, 1999, which is incorporated herein by reference in its entirety. The efficiency of a rising film evaporator can be characterized by the ratio of distillate output per unit time to the heat input to the evaporator per unit time.

### SUMMARY OF THE INVENTION

In accordance with embodiments of the present invention, an improvement is provided for devices that convert liquid to vapor, such as evaporators.

In embodiments of the invention, the evaporator includes a series of substantially vertical tubes serving as heat exchangers, to which a liquid to be distilled is introduced. The tubes are heated on their exteriors and the converted vapor escapes from a vent opening in the top of each tube. In this embodiment, the improvement comprises inserting packing material inside a given evaporator tube to improve the net rate of phase change. The packing may be any material suitable for use with the given liquid under the conditions typically found in an evaporator and may be placed at the top of the tube or the bottom of the tube or any position between the top and the bottom of the tube.

In another embodiment, the packing may be shaped such that the material preferentially fills the volume of the given tube near the tube's longitudinal axis versus the volume near the tube's interior wall. The packing material may extend the length of a tube or any subset thereof. In a further embodiment of the present invention, the packing includes at least one cylindrical rod inserted into a given tube. A given rod may be of any diameter less than the diameter of the tube. Each rod may be of any length up to the entire length of the tube. In a specific embodiment, a rod may be placed anywhere within the tube including placement at the top end of the tube or at the bottom end of the tube. In a specific embodiment the rod extends from the midpoint of the tube to the upper end of the tube.

In another embodiment, the packing is a brush comprising a rod with a plurality of bristles emanating from the rod. In a specific embodiment, the length of the bristles is set so that at least a subset of the bristles contact the inner surface of the tube. In another specific embodiment, the length of the bristles is set so that the bristles do not contact the inner surface of the tube during normal operation. In a further specific embodiment of the present invention, the brush extends the full length of the evaporator tube in which the rod is inserted. In yet another specific embodiment, the brush extends only a portion of the length of a given tube and may be placed anywhere within the tube, including at the top of the tube.

In another embodiment, the packing material may be a loosely packed material, such as wire mesh, inserted into the tube. The loosely packed material may extend the full length of the tube or may extend only a portion of the length of any given tube and may be placed anywhere within the tube, including the top of the tube.

Geometries other than tubes may be employed for the phase change chambers. Such geometries may include parallel core layers or other parallelepiped structures. Packing may fill the chamber either fully or partially.

### BRIEF DESCRIPTION OF THE DRAWINGS

The invention will be readily understood by reference to the following description, taken with the accompanying drawings, in which:

FIG. 1 shows a tube-type evaporator evaporator;

FIG. 2 shows the rate of distillate output for an evaporator as a function of pressure for several liquid boiling modes;

FIG. 3 illustrates an evaporator tube incorporating a rod as packing to enhance boiling of a liquid in a rising film evaporator;

FIG. 4 illustrates an evaporator tube incorporating a brush as packing to enhance boiling of a liquid in a rising film evaporator;

FIG. 5 shows a comparison of the rate of distillate output as a function of pressure for an evaporator for pool boiling and for a tube with rod and wire mesh packing;

FIG. 6 shows a comparison of the rate of distillate output as a function of pressure for an evaporator for pool boiling and for a tube with full and half packing; and

FIG. 7 shows a comparison of the rate of distillate output as a function of pressure for tubes packed with rods of varying diameters.

### DETAILED DESCRIPTION OF SPECIFIC EMBODIMENTS

The present invention advantageously addresses enhancing the efficiency of phase change for liquids, such as in an evaporator. As used in this application, the term “boiling” will be understood to include a phase change between liquid and vapor where no bubbles are formed, as well as a phase change where bubbles are formed.

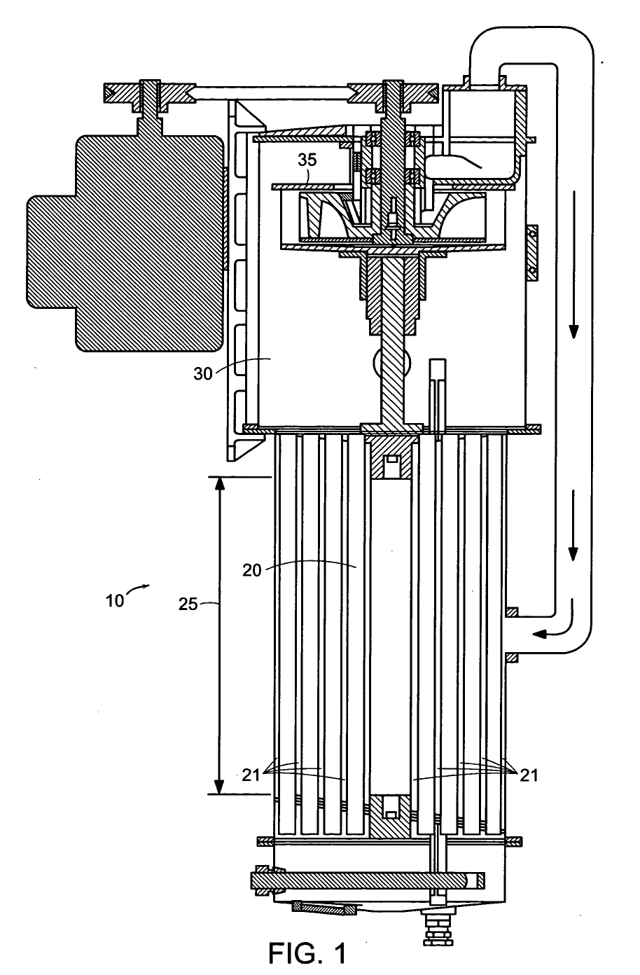

FIG. 1 shows an evaporator 10 for distilling a liquid according to an embodiment of the present invention. The evaporator includes a set 20 of cylindrical evaporator tubes 21 that are substantially vertically oriented. Liquid is introduced to each tube through an inlet at the bottom of each tube. Each tube includes a heated central region 25 for boiling the liquid and producing vapor. Each tube has a vent opening that allows vapor to escape from the tube into an evaporation chamber 30. Liquid that has not undergone phase change also escapes through the vent opening into the chamber where the liquid may be recirculated to the tube inlets.

The central region of the evaporator tubes may be heated by any of several means. One means is by compressed vapor, e.g. steam, in contact with the exterior of each tube. A pump 35, which may be a liquid ring pump, compresses vapor drawn from the evaporation chamber 30, raising the vapor's pressure and temperature. The compressed vapor is channeled to the exterior of the evaporator tubes in the central region. The compressed vapor condenses around the evaporator tubes thereby heating the liquid in the tubes to boiling. The distillate from the condensed vapor is then drained off.

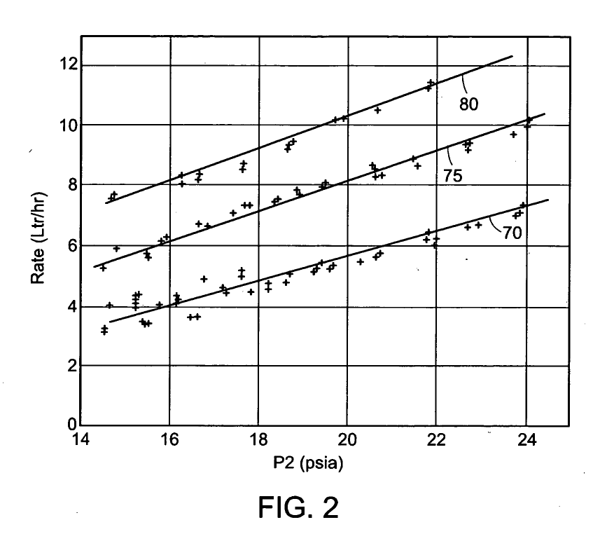

Typically, an evaporator may operate in either of two modes: pool boiling mode or thin film mode. In thin film boiling, a thin film of liquid is created on the inner wall of the tubes facilitating heat transfer from the tube wall to the liquid. The efficiency of phase change typically increases for thin film mode as compared to pool boiling mode. FIG. 2 shows the difference in the rate of distillate production as a function of vapor pressure for pool boiling and thin film boiling under similar conditions for a representative evaporator. The bottom curve 70 corresponds to pool boiling while the middle curve 75 corresponds to thin film boiling. As will be noted from these two curves, thin film boiling mode offers significantly higher efficiency than pool boiling mode. Thin film boiling is more difficult to maintain than pool boiling, however. Thin film evaporation is typically achieved using apparatus that includes very small openings. This apparatus can easily clog, particularly when the source liquid contains contaminants. Additionally, in thin film mode the water level is typically held just marginally above the tops of the tubes in a vertical tube-type evaporator. For reasons such as this, the apparatus may also be sensitive to movement and positioning of the apparatus.

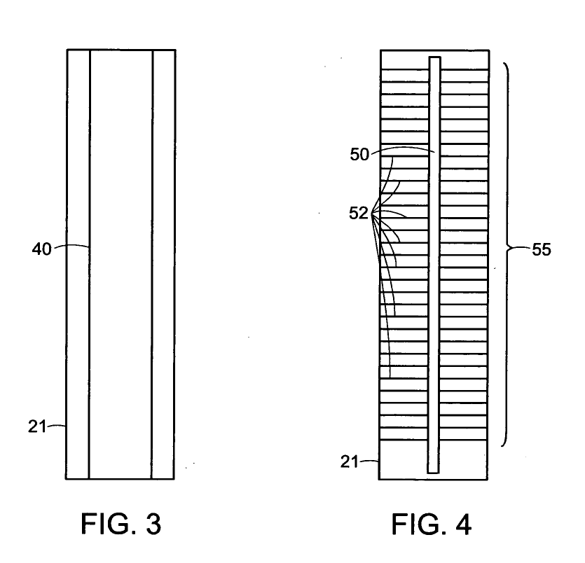

Improved efficiency of a phase change operation is achieved in accordance with embodiments of the present invention by providing packing within the evaporator tubes 21. The introduction of such packing may allow the evaporator to take on some of the characteristics of thin film mode, due to the interaction between the liquid, the packing and the heating tube. The packing may be any material shaped such that the material preferentially fills the volume of a tube near the tube's longitudinal axis versus the volume near the tube's interior wall. Such packing material serves to concentrate the vapor near the walls of the tube for efficient heat exchange. For example, in an embodiment of the present invention shown in FIG. 3, the packing may comprise a rod 40 or a plurality of rods inserted into an evaporator tube 21. Each rod 40 may be of any cross-sectional shape including a cylindrical or rectangular shape. The cross-sectional area of each packing rod 40 may be any area that will fit within the cross-section of the tube. The cross-sectional area of each rod may vary along the rod's length. A given rod may extend the length of a given evaporator tube or any subset thereof.

Each rod may be positioned anywhere within the tube including preferentially in the upper portion of the tube. In a specific embodiment, each brush is approximately half the length of the associated tube and is positioned approximately in the top half of the tube. A given rod may be made of any material including, for example, a metal, nylon, Teflon or plastic and in certain embodiments may be hydrophobic. The top curve 80 in FIG. 2 shows the increase in boiling efficiency for thin film boiling for a representative evaporator where the evaporator tubes include packing material in approximately the top half of the tubes. With such packing, the phase change efficiency is also, advantageously, much less sensitive to changes in the liquid level above the tubes, the orientation of the tubes with respect to the vertical, the feed pressure for the tubes and other operating parameters for the evaporator.

In a specific embodiment of the present invention, as shown in FIG. 4, the packing is in the form of a rod 50 with bristles 52 emanating therefrom, forming a brush 55. The length of the bristles is determined so that a subset of the bristles contacts the inner surface of the tube, when the brush 55 is inserted into the tube. As used in this description and in any appended claims, the word “subset” shall include both proper subsets and a subset that includes every member of the set in question. The brush inserted in any given tube may extend the length of the tube or any portion thereof. Each brush may be positioned anywhere within the tube including at the upper end of the tube. In a specific embodiment, each brush is approximately half the length of the associated tube and is positioned approximately in the top half of the tube. In another embodiment of the invention, the brush is positioned and the length of the bristles is such that none of the bristles contact the evaporator tube wall. In other embodiments of the invention, the packing may be a mesh or other loose packed material.

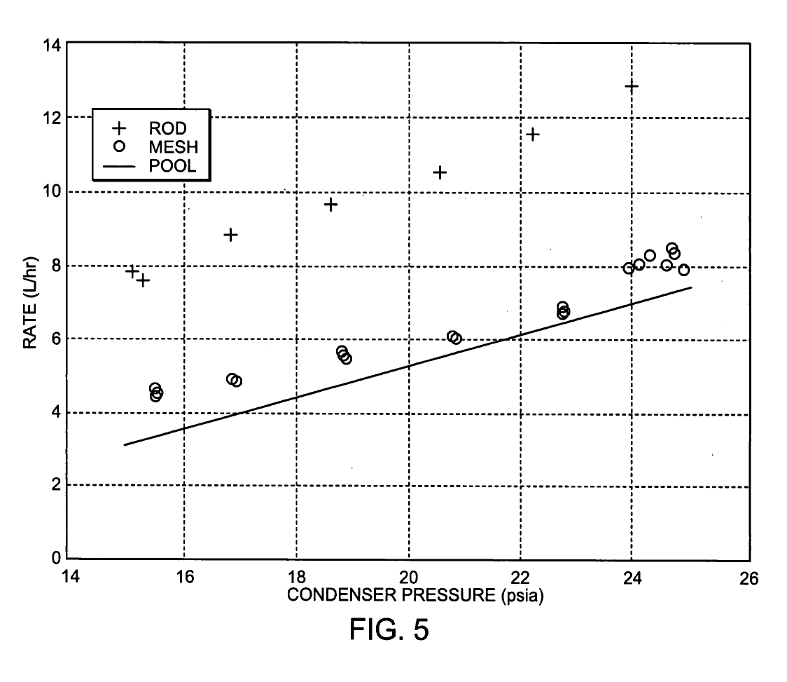

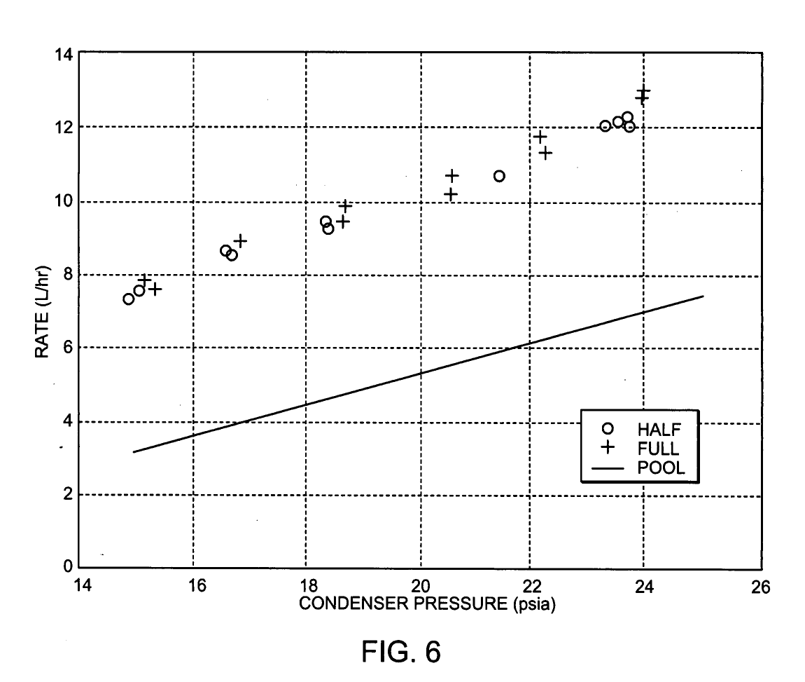

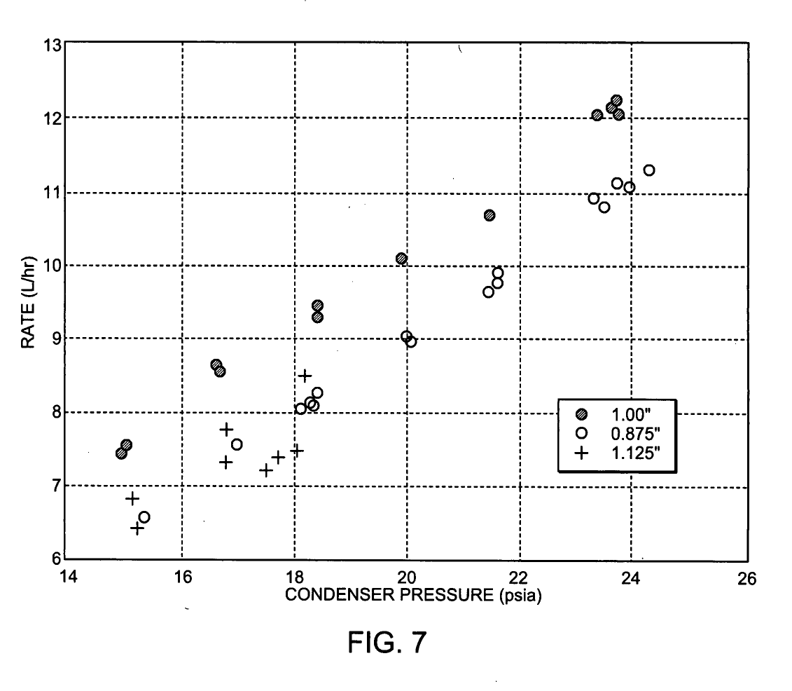

As an example, an evaporator was built with 10 tubes, with each tube 1.25 inches in diameter and 18 inches in length. The distillation rate as a function of condenser pressure was measured with a variety of packing in the evaporator tubes. For example, FIG. 5 shows the distillation rate for no packing in the tubes (i.e., pool boiling mode), for a mesh packing and for packing consisting of rods. The graph clearly shows that the rod packing significantly enhanced the output rate of the evaporator as compared to pool boiling while the mesh provided a less significant improvement in output rate as compared to pool boiling. FIG. 6 compares the output for evaporator tubes with a rod inserted for its full length and with a rod inserted for half of its length. As can be readily seen, the output rate appears to be insensitive to the length of the rods in these two cases. Finally, FIG. 7 shows the results from inserting rods with 0.875 inch, 1.00 inch and 1.125 inch diameters respectively into the upper half of the evaporator tubes. As can be seen, the output is maximized for the intermediate diameter rod (1.00 inch). This phenomenon may be due to the intermediate diameter rod allowing the flow rate of steam past the rod to be increased as compared to the smallest rod (0.875 inch), while avoiding the restricted flow past the rod that the largest rod (1.125 inch) may provide.

In other embodiments, the evaporator or condenser may include formats other than tubes, such as the flat evaporator/condenser disclosed in U.S. provisional patent application Ser. No. 60/425,820, filed Nov. 13, 2002, entitled “Pressurized Vapor Cycle Liquid Distillation,” incorporated herein by reference in its entirety. Such flat evaporator/condensers typically contain multiple parallel core layers, with rib sections creating channels for directing steam and condensed liquid flow. In this embodiment, the improvement comprises inserting packing material inside a given evaporator layer to improve the net rate of phase change. The packing may be any material suitable for use with the given liquid under the conditions typically found in an evaporator and may be placed along the entire length of the evaporator layer or any portion thereof. In this embodiment, the packing may be shaped such that the material preferentially fills the center of the evaporator layer and may be of any thickness less than the thickness of the evaporator layer. The packing may be any solid or hollow shape or may comprise a rod with a plurality of bristles emanating from the rod. In a specific embodiment, the length of the bristles is set so that at least a subset of the bristles contact both the upper and lower surface of the evaporator layer. In another embodiment, the packing material may be a loosely packed material, such as wire mesh, inserted into the evaporator layer.

In this specification and in any appended claims, unless context requires otherwise, the term “phase change chamber” will mean any structure with at least one inlet end for introducing liquid and at least one outlet end for allowing vapor to exit. The chamber is intended to be heated externally and to allow a liquid-to-vapor phase change to occur within. Such chambers include, without limitation, evaporator tubes, that may be cylindrical, and the parallel core layers described above. Other geometries as are known for such chambers to those skilled in the art are intended to be within the scope of the invention as described in the claims.

In yet another embodiment of the invention, rather than inserting packing material into an evaporator tube or a flat layer of an evaporator/condenser, the evaporator may be fabricated to achieve similar results with respect to increased efficiency. For example, in an evaporator containing substantially vertical tubes, the tubes may be formed with a permanent cylindrical section, similar to a rod, placed in the center of the tube. Additionally, for example, a flat evaporator/condenser may be formed with plates that are placed at appropriately spaced intervals to achieve a similar result to the use of packing materials.

Having thus described various illustrative embodiments of the present invention, some of its advantages and optional features, it will be apparent that such embodiments are presented by way of example only and not by way of limitation. Those skilled in the art can readily devise alterations and improvements on these embodiments, as well as additional embodiments, without departing from the spirit and scope of the invention. All such modifications are within the scope of the invention as defined by the appended claims.

What is claimed is:

1. An evaporator for distilling a liquid, the evaporator comprising:
a. a plurality of phase change chambers, each chamber having a liquid inlet end and an outlet end, each chamber having an evaporation region wherein each chamber can be heated externally, each chamber characterized by an interior; and
b. packing in the interior of at least one chamber.

2. The evaporator of claim 1, wherein at least one chamber is a tube.

3. The evaporator of claim 1, wherein at least one chamber is a parallel core layer.

4. The evaporator of claim 1, wherein the packing for a given chamber includes at least one rod.

5. The evaporator of claim 4, wherein the length of the rod extends the length of the chamber.

6. The evaporator of claim 4, wherein the length of the rod extends less than the length of the chamber.

7. The evaporator of claim 4, wherein the rod includes a plurality of bristles emanating therefrom.

8. The evaporator of claim 1, wherein the packing is plastic.

9. The evaporator of claim 1, wherein the packing is hydrophobic.

10. The evaporator of claim 1, wherein the packing is a mesh.

11. A method for enhancing distillation in an evaporator, the evaporator including a plurality of phase change chambers, each chamber having a central evaporation region and characterized by an interior, the method comprising:
a. inserting packing in the interior of at least one chamber;
b. introducing a liquid to the chamber; and
c. heating the chambers external to the region to produce a vapor.

12. The method of claim 11, wherein the packing comprises a rod with a plurality of bristles emanating therefrom.

13. The method of claim 11, wherein the packing for a given chamber extends the length of the given chamber.

14. The method of claim 11, wherein the packing material for a given chamber extends less than the length of the given chamber.

15. The method of claim 11, wherein the packing is hydrophobic.

16. The method of claim 11, wherein the packing is a plastic.

17. The method of claim 11, wherein the packing is a mesh.

18. The method of claim 11, wherein at least one chamber is a tube.

19. The method of claim 11, wherein at least one chamber is a parallel core layer.
